(19) United States
(12) Patent Application Publication
(10) Pub. No.: US 2010/0240809 A1
(43) Pub. Date: Sep. 23, 2010

(54) Rubber Composition and Rubber Belt

(75) Inventor: Tomoyuki Yamada, Hyogo (JP)

Correspondence Address: THE WEBB LAW FIRM, P.C., 700 KOPPERS BUILDING, 436 SEVENTH AVENUE, PITTSBURGH, PA, 15219, US

(73) Assignee: BANDO CHEMICAL INDUSTRIES, LTD., Kobe-shi, Hyogo (JP)

(21) Appl. No.: 12/741,399

(22) PCT Filed: Oct. 27, 2008
(86) PCT No.: PCT/JP2008/069465

§ 371 Date: May 5, 2010

(30) Foreign Application Priority Data
Nov. 9, 2007 (JP) 2007-291972

(51) Int. Cl. C08K 5/16

(52) U.S. Cl. 524/81

(57) ABSTRACT

An object is to provide a rubber composition that is capable of significantly improving mechanical properties. Another object is to provide a rubber belt that has excellent mechanical properties. Provided are a rubber composition, and a rubber belt formed by using the rubber composition, which is incorporated with a rubber component containing an ethylene/α-olefin copolymer, and an organically treated clay mineral organically treated with an organic ammonium ion, wherein the ethylene content of the ethylene/α-olefin copolymer is in a range of 60-85% by mass, the rubber component has a Mooney viscosity of 10-55 at 125° C., and the organically treated clay mineral is incorporated in 6-30 parts by mass per 100 parts by mass of the rubber component.

### FIELD OF THE INVENTION

The present invention relates to a rubber composition and a rubber belt using the same.

### RELATED ART

It is conventionally known to improve mechanical properties, such as breaking strength and breaking elongation, of a rubber mold by the use of a rubber composition that contains a rubber component containing an ethylene/α-olefin copolymer having excellent thermal resistance, and an organically treated clay mineral.

For example, Patent Document 1 proposes to use a rubber composition incorporated with an ethylene/α-olefin copolymer as a rubber component, a montmorillonite organically treated with octadecylamine, and an epoxy compound, thereby improving the mechanical properties of a rubber mold formed from the rubber composition. Patent Document 2 proposes to add a vulcanizing agent and a vulcanization accelerator to a rubber composition incorporated with a rubber component containing an ethylene/α-olefin copolymer, and a montmorillonite organically treated with octadecylamine, thereby improving the mechanical properties of a rubber mold formed from the rubber composition. Furthermore, Patent Document 3 proposes to use a rubber composition incorporated with a rubber component containing a polar group-containing ethylene/α-olefin copolymer, and a montmorillonite organically treated with octadecylamine, thereby improving the mechanical properties of a rubber mold crosslinked with the rubber composition.

The mechanical properties to be improved with the rubber composition of the above kind are breaking strength and breaking elongation, of a rubber mold formed from this composition, but bending resistance or flexural stiffness of the same as one of the mechanical properties could not have been satisfactorily improved yet. As such, there is a demand for a rubber composition that is capable of improving the mechanical properties including not only the breaking strength and breaking elongation, but also the bending resistance or flexural stiffness, of a rubber mold. For a mold such as a rubber belt using a rubber composition, there is a demand for improvement in its mechanical properties, such as bending resistance or flexural stiffness.

Patent Document 1: Japanese Patent Application Laid-open No. 2004-256730

Patent Document 2: Japanese Patent Application Laid-open No. 2000-080207

Patent Document 3: Japanese Patent Application Laid-open No. 2000-159937

### DISCLOSURE OF THE INVENTION

### Problems to be Solved by the Invention

In consideration of the above problem and the demand, it is an object of the present invention to provide a rubber composition that is capable of significantly improving the mechanical properties of a mold. It is another object of the present invention to provide a rubber belt that is excellent in mechanical properties.

### Means for Solving Problems

In order to solve the above problem, according to the present invention, there is provided a rubber composition that is incorporated with a rubber component containing an ethylene/α-olefin copolymer, and an organically treated clay mineral organically treated with an organic ammonium ion, wherein the ethylene content of the ethylene/α-olefin copolymer is in a range of 60-85% by mass, the rubber component has a Mooney viscosity of 10-55 at 125° C., and the organically treated clay mineral is incorporated in 6-30 parts by mass per 100 parts by mass of the rubber component.

When the ethylene content of the ethylene/α-olefin copolymer is less than 60% by mass, the mechanical properties of a rubber mold, such as a rubber belt, may not be significantly improved. In respect of difficulty in obtaining commercially available products, the ethylene content is preferably not more than 85% by mass.

When the Mooney viscosity of the rubber component at 125° C. is beyond 55, the mechanical properties of a rubber mold, such as a rubber belt, may not be significantly improved. A rubber component having a Mooney viscosity of less than 10 may not be formed from commercially available rubber. In respect of easiness in obtaining a material, the value of a Mooney viscosity of the rubber component is preferably not less than 10.

When the content of the organically treated clay mineral is not more than 6 parts by mass per 100 parts by mass of the rubber component, the mechanical properties of a rubber mold, such as a rubber belt, may not be significantly improved when compared with a rubber mold using a conventional rubber composition. When the content is beyond 30 parts by mass, the mechanical properties of a rubber mold, such as a rubber belt, may be deteriorated.

According to the rubber composition of the present invention, a mold formed by vulcanization molding preferably has breaking strength of 25-35 MPa and breaking elongation of 550-700%.

According to the present invention, there is provided a rubber belt that is incorporated with a rubber component including an ethylene/α-olefin copolymer, and an organically treated clay mineral organically treated with an organic ammonium ion, wherein the ethylene content of the ethylene/α-olefin copolymer is in a range of 60-85% by mass, the rubber component has a Mooney viscosity of 10-55 at 125° C., and the organically treated clay mineral is incorporated in 6-30 parts by mass per 100 parts by mass of the rubber component.

### ADVANTAGES OF THE INVENTION

As described above, the rubber composition of the present invention produces an advantageous effect that the mechanical properties of a mold formed by the rubber composition can be significantly improved. Thus, the rubber belt of the present invention can be provided with excellent mechanical properties.

### BRIEF DESCRIPTION OF THE DRAWINGS

FIG. 1 is a cross sectional view showing a V-ribbed belt of one embodiment.

FIG. 2 is a schematic view showing a belt running testing machine.

### DESCRIPTION OF THE REFERENCE NUMERALS

1: V-ribbed belt, 2: back surface layer (canvas), 3: adhesive layer, 4: tensile member (core wire), 5: compression layer, 6: rib

### DETAILED DESCRIPTION OF THE PREFERRED EMBODIMENT

Now, the description will be made for an embodiment of a rubber composition of the present invention.

A rubber composition of this embodiment is incorporated with a rubber component including an ethylene/α-olefin copolymer and an organically treated clay mineral organically treated with an organic ammonium ion. The ethylene content of the ethylene/α-olefin copolymer is 60-85% by mass, the Mooney viscosity of the rubber component at 125° C. is 10-55, and the organically treated clay mineral is incorporated in 6-30 parts by mass per 100 parts by mass of the rubber component.

As the aforesaid rubber component, rubber components other than the ethylene/α-olefin copolymer may be contained. The ethylene/α-olefin copolymer contained in the rubber component is incorporated preferably in the amount of 40-100% by mass and more preferably in the amount of 80-100% by mass. With the ethylene/α-olefin copolymer occupying 40% by mass or more of the rubber component, there is an advantage in that the resulting rubber mold is provided at low cost while exhibiting excellent thermal resistance and weather resistance. With the ethylene/α-olefin copolymer occupying 100% by mass, there is an advantage that the resulting rubber mold is provided at low cost, while exhibiting excellent thermal resistance and weather resistance, and does not contain halogen in a rubber component, which may cause hazardous substances when in burning or the like. As such, a rubber component, which contains the ethylene/α-olefin copolymer, preferably consists of ethylene/α-olefin copolymer only.

The ethylene/α-olefin copolymer is formed by copolymerizing at least ethylene and α-olefin. Examples of the ethylene/α-olefin copolymer include ethylene-propylene copolymer, ethylene-propylene-diene copolymer, ethylene-octene copolymer and ethylene-butene copolymer. Among them, ethylene-propylene-diene copolymer (EPDM) is preferable from the viewpoints that it is manufactured at low cost, has excellent processability and is easy to be cross-linked. Ethylene-propylene-ethylidenenorbornene copolymer is more preferable from the viewpoints that its sulfur vulcanization speed is high and it can exhibit well balanced physical properties after vulcanization. One or two or more kinds of ethylene/α-olefin copolymer may be contained in the rubber composition.

The ethylene content of the ethylene/α-olefin copolymer is 60-85% by mass. When the ethylene content is less than 60% by mass, the mechanical properties of a rubber mold, such as a rubber belt, may not be significantly improved when compared with a conventional rubber mold. A commercially available product with an ethylene content of more than 85% by mass is difficult to be obtained, and therefore the rubber composition of this embodiment is incorporated with an ethylene content of more than 85% by mass from the viewpoint that the incorporation with this proportion is easy to be made by using a commercially available product.

In a case where plural kinds of ethylene/α-olefin copolymer is incorporated into the rubber composition of this embodiment, a weight average ethylene content may be 60-85% by mass, and for example, it falls within the scope of the present invention to mix equal amounts of ethylene/α-olefin copolymer having an ethylene content of 55% by mass and ethylene/α-olefin copolymer having an ethylene content of 85% by mass to have an average ethylene content of 70% by mass.

However, from the viewpoint that the mechanical properties of a mold can be more securely improved, every ethylene/α-olefin copolymer to be contained has an ethylene content in a range of 60-85% by mass.

The ethylene content may be adjusted by adjusting the amount of the ethylene/α-olefin copolymer when in copolymerization.

For the ethylene/α-olefin copolymer, a commercially available product may be used.

Examples of the other rubber component include conventionally used rubber, such as natural rubber, polyisoprene, epoxidized natural rubber, styrene-butadiene copolymer, polybutadiene, acrylonitrile-butadiene copolymer, hydrogenated acrylonitrile-butadiene copolymer, butyl rubber, chlorosulfonated polyethylene, alkylated-chlorosulfonated-polyethylene and chlorinated polyethylene. These may be solely used or in combination in the rubber composition of this embodiment.

The rubber component contains the ethylene/α-olefin copolymer, and may contain other rubber components, as well. The Mooney viscosity of the rubber component at 125° C. is 10-55. This Mooney viscosity is measured by using the rubber component before crosslinking. When the Mooney viscosity exceeds 55, the mechanical properties of a rubber mold, such as a rubber belt, may not be significantly improved. Also, a rubber component having a Mooney viscosity of less than 10 may not be formed by using commercially available rubber. As such, the Mooney viscosity of the rubber component is preferably higher than 10 from the view point that a material thereof is easy to be obtained.

The Mooney viscosity may be adjusted by, for example, adjusting the molecular weight of each rubber component. Specifically, the Mooney viscosity can be decreased by increasing the molecular weight of rubber constituting a rubber component, while the Mooney viscosity can be increased by decreasing the molecular weight of rubber constituting a rubber component.

The Mooney viscosity is used as an index representing viscosity, and is a value measured by the method stipulated by JIS K6300-1:2001. More specifically, the measurement is performed with a rotor shape of L, a preheating time of 1 minute, and a rotor rotating time of 4 minutes. Here, in the expression of ML₁₊₄(125° C.)25, M represents “M” of Mooney, L represents an L-shape of a rotor, (1+4) represents 1 minute of preheating and 4 minutes of a rotating time of a rotor, and 25 represents a value of a Mooney viscosity.

The organically treated clay mineral is a clay mineral organically treated with an organic ammonium ion. The organically treated clay mineral may be obtained by having the clay mineral reacted with the organic ammonium ion. A commercially available organically treated clay mineral may be used.

The amount of the organically treated clay mineral to be incorporated into the rubber composition is 6-30 parts by mass per 100 parts by mass of the rubber component. When the amount of the organically treated clay mineral is less than 6 parts by mass per 100 parts by mass of the rubber component, the mechanical properties of a rubber mold, such as a rubber belt, may not be significantly improved when compared with a conventional rubber mold. When the amount exceeds 30 parts by mass, the mechanical properties of a rubber mold, such as a rubber belt, may be deteriorated.

The amount of the organically treated clay mineral to be incorporated into the rubber composition is preferably 10-30 parts by mass per 100 parts by mass of the rubber component. When the amount of the organically treated clay mineral is 10 parts by mass or more per 100 parts by mass of the rubber component, there is an advantage that the mechanical properties of a rubber mold, such as a rubber belt, can be significantly improved.

The mass of the organically treated clay mineral represents not the mass of a clay mineral before organic treatment, but the mass of a clay mineral after organic treatment.

An example of the clay mineral includes a laminar clay mineral having a layer structure. This laminar clay mineral is a main component of a clay, and an example of the laminar clay mineral includes a silicate mineral having a laminar crystal structure. Here, an example of the laminar crystal structure includes a structure having three layers laminated together, namely a silicate tetrahedral layer, an alumina octahedral layer and a silicate tetrahedral layer. Each layer has a thickness of about 1 nm, and an interval between the adjacent layers is 0.1-1 μm, and thus the structure is of a very thin plate shape.

The laminar clay mineral is generally of a plate structure having a high aspect ratio. With the plate structure having a high aspect ratio dispersed in a high molecular composition, it is expected to improve the thermal resistance, the flame resistance, the gas barrier property, the dimensional resistance, etc., of the high molecular composition.

The laminar clay mineral has its properties varied depending on the difference in negative charge density or distribution of each layer.

The laminar clay mineral has preferably a cation exchange capacity of a clay mineral being 50-200 meq/100 g, from the viewpoint that it can cause its layers greatly open to the outside to make itself swell. With the cation exchange capacity of 50 or higher meq/100 g, there are advantages that ammonium ion exchange is easy to be made, and a clay mineral is easy to swell. With the cation exchange capacity of 200 meq/100 or lower, there are advantages that the interlaminar bonding strength of a clay mineral is not easy to increase, and a clay mineral is easy to swell.

The laminar clay mineral may be a laminar phyllosilicate constituted by, such as magnesium silicate or aluminium silicate, which is isomorphously replaced by a less charged ion and thus negatively charged. The layer thickness may be in a range of 0.6-2 nm and a length of a piece may be in a range of 2-1000 nm.

Examples of the laminar clay mineral include a smectite clay mineral, such as montmorillonite, saponite, beidellite, nontronite, hectorite and stevensite, vermiculite, halloysite, swellable mica, and kaolinite. These may be used solely or in combination and incorporated into the rubber composition. These may be natural or synthesized materials. Among them, montmorillonite is preferable due to its excellent dispersibility.

An organic ammonium ion for organically treating the organically treated clay mineral is replaced with an alkali metal ion and an alkali earth metal ion, etc., present in the interlaminar zone, thereby facilitating separation of the layers by shearing force and enabling improvement of compatibility with an organic matter, such as a rubber component in a rubber composition. The organic ammonium ion has a structure having an alkyl chain in a molecule, and/or having a part of an alkyl chain in a molecule covalently bonded with carboxylic acid, and is an organic matter having an ammonium ion group. From the viewpoint of improving compatibility with an organic matter, such as a rubber component in a rubber composition, the carbon number of an alkyl chain is preferably 6 or more.

Examples of the organic ammonium ion include saturated organic ammonium ion, such as hexylammonium ion, octylammonium ion, 2-ethyl-hexylammonium ion, dodecylammonium ion, octadecylammonium ion, dioctyldimethyl ammonium ion, trioctylammonium ion, dimethyldioctadecylammonium ion, trimethyloctadecyl ammonium ion, dimethyloctadecylammonium ion, methyloctadecylammonium ion, trimethyldodecylammonium ion, dimethyldodecylammonium ion, methyldodecylammonium ion, trimethylhexadecylammonium ion, dimethylhexadecylammonium ion, methylhexadecylammonium ion and dimethylstearylbenzylammonium ion, and unsaturated organic ammonium ion, such as 1-hexenylammonium ion, 1-dodecenylammonium ion, 9-octadecenylammonium ion (oleylammonium ion), 9,12-octadecadienylammonium ion (rinolammonium ion), 9,12,15-octadecatrienylammonium ion (rinoleylammonium ion) and oleylbis-(2-hydroxyethyl)methylammonium ion. Or, an example of the organic ammonium ion includes a mixture of plural kinds. Among them, from the viewpoint that the mechanical properties of a rubber mold, such as a rubber belt, can be significantly improved, dimethyldioctadecylammonium ion and trimethyloctadecylammonium ion are preferable, and dimethyldioctadecylammonium ion is more preferable.

As the organically treated clay mineral, organically treated montmorillonite is preferable. Examples of the organically treated montmorillonite include hexylammonium-treated montmorillonite, octylammonium-treated montmorillonite, 2-ethylhexylammonium-treated montmorillonite, dodecylammonium-treated montmorillonite, octadecylammonium-treated montmorillonite, dioctyldimethylammonium-treated montmorillonite, trioctylammonium-treated montmorillonite, dimethyldioctadecylammonium-treated montmorillonite, trimethyloctadecylammonium-treated montmorillonite, dimethyloctadecylammonium-treated montmorillonite, methyoctadecylammonium-treated montmorillonite, trimethyldodecylammonium-treated montmorillonite, dimethyldodecylammonium-treated montmorillonite, methldodecylammonium-treated montmorillonite, trimethylhexadecylammonium-treated montmorillonite, dimethylhexadecylammonium-treated montmorillonite, methylhexadecylammonium-treated montmorillonite, dimethylstearylbenzylammonium-treated montmorillonite and oleylbis-(2-hydroxyethyl)methylammonium-treated montmorillonite. They may be solely used or used in combination and incorporated into a rubber composition. Among them, from the viewpoint that the mechanical properties of a rubber mold, such as a rubber belt, can be significantly improved, dimethyldioctadecylammonium-treated montmorillonite and trimethyloctadecylammonium-treated montmorillonite are preferable, and dimethyldioctadecylammonium-treated montmorillonite is more preferable.

The organic matter content of the organically treated clay mineral is preferably 25-42% by mass. With the content being 25% by mass or more, there is an advantage that the organically treated clay mineral is easy to be more evenly distributed in a rubber composition. With the content being 42% by mass or lower, there is an advantage that the organically treated clay mineral is easy to be more evenly distributed in a rubber composition. The organic matter content is a value determined by thermogravimetry described below. The organic matter content may be adjusted by changing the amount of organic ammonium ions to be reacted with a clay mineral.

The organic matter content is determined by thermogravimetry, and specifically is determined by measuring organic matter of the organically treated clay mineral (organic matter replaced with a sodium ion) by a thermogravimetry device (Trade name: TG/DTA-110, manufactured by Seiko Instruments Inc.). The measuring conditions are: reference; alumina, measuring temperature range; 25-600° C., and heating rate; 10° C./min. After heated to 600° C., the temperature is held for 10 minutes.

The rubber composition may be incorporated with a vulcanizing agent, a vulcanization accelerator, a vulcanization auxiliary agent, an inorganic filler and the like, which are generally used in a conventional rubber composition, as well as a plasticizer, such as carbon black and oil, an antioxidant, and a processing aid, to such an extent as not to deteriorate the advantageous effects of the present invention.

As the vulcanizing agent, a sulfur vulcanizing agent or an organic peroxide vulcanizing agent may be used. Examples of the sulfur vulcanizing agent include powdered sulfur, precipitated sulfur, high dispersing sulfur, surface treated sulfur, insoluble sulfur, dimorpholine disulfide and alkylphenol disulfide. Examples of the organic peroxide vulcanizing agent include di-t-butylperoxide, dicumil peroxide, t-butylcumil peroxide, 1,1-t-butylperoxy-3,3,5-trimethylcyclohexane, 2,5-dimethyl-2,5-di-(t-butylperoxy) hexane, 2,5-dimethyl-2,5-di-(t-butylperoxy)hexyne-3, bis(t-butylperoxy)diisopropyl benzene, 2,5-dimethyl-2,5-di(benzoilperoxy)hexane, t-butylperoxybenzoate and t-butylperoxy-2-ethyl-hexyl carbonate.

Examples of the vulcanization accelerator to be used include a zinc dithiocarbamate vulcanization accelerator, such as piperidinium pentamethylene dithiocarbamate, pipecoline pipecoryl dithiocarbamate, zinc dimethyl dithiocarbamate, zinc diethyl dithiocarbamate, zinc dibutyl dithiocarbamate, zinc N-ethyl-N-phenyl dithiocarbamate, zinc N-pentamethylene dithiocarbamate, zinc dibenzyl dithiocarbamate, sodium diethyldithiocarbamate, sodium dibutyldithiocarbamate, copper dimethyldithiocarbamate, ferric dimethyldithiocarbamate and tellurium dimethyldithiocarbamate.

Also usable is a thiazole, thiuram or sulphenamide vulcanization accelerator. Examples of the thiazole vulcanization accelerator include 2-mercaptobenzothiazole, 2-mercaptothiazoline, dibenzothiazyl disulfide, and 2-mercaptobenzothiazole zinc salt. Examples of the thiuram vulcanization accelerator include tetramethylthiuram monosulfide, tetramethylthiuram disulfide, tetraethylthiuram disulfide, and N,N′-dimethyl-N,N′-diphenylthiuram disulfide. Examples of the sulphenamide vulcanization accelerator include N-cyclohexyl-2-benzothiazile sulfonamide, and N,N′-cyclohexyl-2-benzothiazile sulfonamide. Another examples of the vulcanization accelerator include bismaleimide and ethylenethiourea. These vulcanization accelerators may be used solely or in combination of two or more kinds thereof in admixture.

Examples of the vulcanization aid includes fatty acid such as stearic acid, and metal oxide such as zinc oxide.

Examples of the crosslinking aid include triallyl cyanurate, triallyl isocyanurate, 1,2-polybutadiene, metal salt of unsaturated carbonic acid, oxime, guanidine, trimethylolpropane trimethacrylate, ethylene glycol dimethacrylate, and N,N′-m-phenylene bismaleimide.

Examples of the inorganic filler include aluminum hydroxide, magnesium hydroxide, calcium hydroxide, zinc hydroxide and hydrotalcite.

Examples of the carbon black include carbon black for rubber use, such as FEF, ISAF and HAF, categorized by general names. The content of the carbon black in the rubber composition is preferably 30-100 parts by mass per 100 parts by mass of the rubber component. With the content being 30-100 parts by mass, there is an advantage that the elastic modulus of a mold after crosslinking is appropriately maintained.

Thus, incorporating the carbon black into the rubber composition produces an advantageous effect when the rubber composition of this embodiment is applied to a rubber belt. This is because a rubber mold, such as a rubber belt, is provided with a stiffness suitable for an intended use, by adjusting the content of carbon black. It is to be noted that a rubber mold, such as a rubber belt, tends to become embrittled when carbon black is excessively contained.

According to the rubber composition, a mold formed by vulcanization molding has preferably breaking strength of 25-35 MPa and breaking elongation of 550-700%. The breaking strength and the breaking elongation are measured by the method described in an Example.

The rubber composition can be manufactured by a conventional method. Specifically, the rubber composition can be manufactured by kneading a rubber composition containing the aforesaid components in a predetermined ratio by using, for example, a biaxial extruder, a kneader, a Banbury mixer or the like.

The thus manufactured rubber composition may be molded by injection molding, extrusion molding, compression molding, vacuum molding or slash molding, and subjected to vulcanization treatment according to needs and circumstances, and used as various kinds of mold.

When the organically treated clay mineral is prepared by a clay mineral and an organic ammonium ion, it may be prepared by, for example, the following manner. A clay mineral, which has not yet been organically treated, is added into a solution with an organic ammonium ion, water and hydrochloric acid blended together, and then stirred for a predetermined time while being heated. While rinsing with excessive water, the water content is removed by suction filtration or the like to obtain an aggregated matter, then this aggregated matter is dried by vacuum drying or the like, and then the dried aggregated matter is crashed by a mixer, a ball mill, a vibration mill, a pin mill, a jet mill, a swing dissolver or the like to be adjusted to a predetermined shape and size. Thus, an organically treated clay mineral is prepared.

Now, the description will be made for a rubber belt of the present invention.

Examples of the types of the rubber belt of the present invention include a conveyor belt, and a power transmission belt, such as a V-ribbed belt, a V-belt, a flat belt and a round belt. These rubber belts each are formed by using a rubber composition of the present invention for at least a part of each belt.

Herein, a more specific description will be made for a V-ribbed belt using the rubber composition for its compression layer, as one embodiment of the rubber belt of the present invention, with reference to the drawings attached hereto.

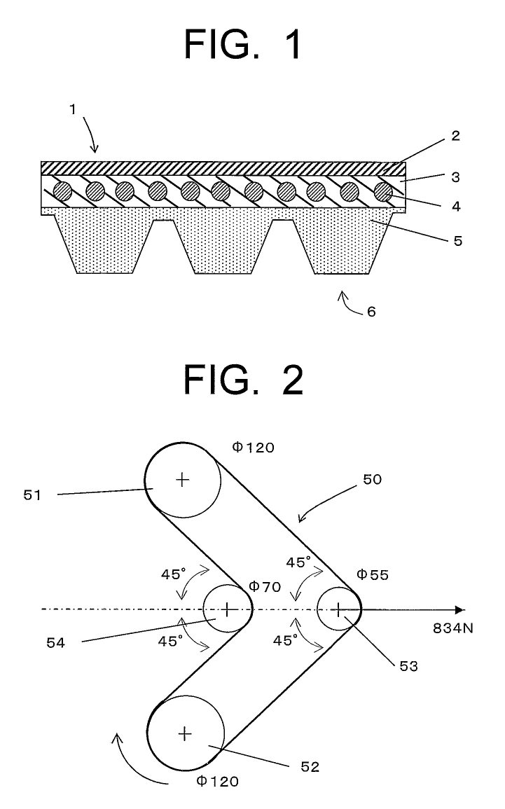

FIG. 1 shows a preferable form of a V-ribbed belt 1 as one embodiment of the rubber belt.

The V-ribbed belt 1 of this embodiment is formed into an endless shape, and has plural (specifically three) ribs 6 along the width direction of the belt each having a cross section shaped into a trapezoid gradually decreasing in width towards an inner circumference, as shown in FIG. 1.

A compression layer 5 is formed as an inner rubber layer on the inner circumferential side of the V-ribbed belt, that is, on the side positioned to inwardly face when the belt is wound around pulleys, an adhesive layer 3 is formed on an outer circumferential side of the compression layer 5, and a back side layer 2 is formed as an outermost layer of the V-ribbed belt 1 on the outer circumferential side of the adhesive layer 3.

The compression layer 5 is formed by a rubber composition that is incorporated with a rubber component containing an ethylene/α-olefin copolymer, and an organically treated clay mineral, wherein the ethylene content of the ethylene/α-olefin copolymer is in a range of 60-85% by mass, the rubber component has a Mooney viscosity of 10-55 at 125° C., and the organically treated clay mineral is incorporated in 6-30 parts by mass per 100 parts by mass of the rubber component. Core wires 4 as a tensile member are embedded in the adhesive layer 3 at the center in the thickness direction for the purpose of reinforcing the belt. The back side layer 2 is formed by using canvas.

The compression layer 5 has two lines of grooves continuously extending in the belt length direction and having a substantially V-shaped cross section, and is formed so as to have three lines of ribs 6 separated from each other with the grooves extending in the belt length direction. The ribs 6 each have a width decreasing as it advances towards the inner circumferential side.

Although the compression layer 5 is allowed to contain short fibers, the compression layer 5 preferably does not contain short fibers for the reason that the processing steps in manufacturing a rubber belt can be reduced. Examples of the short fibers include those having a length of 0.1-8 mm in the longitudinal axis direction, and the ratio of the length relative to a thickness (L/D) being in a range of 30-300. Examples of a material of the short fibers include, without intention to limit, polyamide having an aliphatic structure in a molecule, aramid as a wholly aromatic polyamide resin, acetalized polyvinyl alcohol, polyester, etc.

The adhesive layer 3 is formed with a thickness of, generally 0.1-10 mm. An example of a rubber composition of the adhesive layer 3 includes a rubber composition, which is generally used for an adhesive layer of a V-ribbed belt.

The core wires 4 used in the adhesive layer 3 are of a cord shape having a diameter of a lateral cross section being 0.2-5 mm, are embedded in the belt length direction when in use. No limitation is intended to the kind of material of the core wires, and examples thereof include polyester, such as polyethylene terephthalate and polyethylene naphthalate, polyamide having an aliphatic structure in a molecule, aramid as a wholly aromatic polyamide resin, synthetic fiber, such as acetalized polyvinyl alcohol, glass fiber, steel cord, etc.

The ratio of the thickness of the adhesive layer 3 relative to the thickness of the core wires 4 is generally in a rage of (the thickness of the adhesive layer/the thickness of the core wires) 0.5-2.

As the core wires 4, those treated with an adhesive treating liquid to carry adhesive, are usable. Although there is no necessity to have cords treated with an adhesive treating liquid to carry an adhesive, an adhesive is preferably carried on the core wires 4 since the adhesive further increases the bonding force between the core wires 4 and the rubber composition.

An example of the adhesive includes a resorcin-formalin-latex adhesive (hereinafter referred also to as an RFL adhesive) without intention to limit. The RFL adhesive is preferable from the viewpoint that it is available generally at relatively low cost.

The RFL adhesive is prepared by condensing resorcin and formalin in the presence of the basic catalyst at a mole ratio of resorcin and formalin of 1/3-3/1, and thereby preparing an aqueous solution having a concentration of a resorcin and formalin resin (a resorcin-formalin initial condensate, hereinafter referred to RF) being 5-80% by mass, and then mixing this intermediate with rubber latex. In the RFL adhesive, the solid content concentration is generally in a range of 10-50% by mass without intention to limit. Preferable examples of rubber latex include, without intention to limit, vinylpyridine-styrene-butadiene, butadiene, styrenebutadiene, 2,3-dichlorobutadiene, chlorosulfonated polyethylene, alkylchlorosulfonated polyethylene, and a mixture of these copolymers. A more preferable example of the rubber latex includes at least one kind selected from the group consisting of vinylpyridine-styrene-butadiene, butadiene and styrenebutadiene. These may be laminated together to form plural RFL layers, or two or more kinds of latex may be mixed together. A preferable mass ratio of resorcin-formalin admixture and latex is: resorcin-formalin admixture/latex=0.5-0.1/1.

For example, as a pre-treatment of the core wires 4 before treated with an RFL adhesive treating solution, the core wires 4 may be treated with an adhesive treating solution containing an epoxy compound and/or an isocyanate compound to carry an adhesive of a two layer structure.

An example of the epoxy compound includes a reaction product of a polyhydric alcohols such as ethyleneglycol, glycerin and pentaerythritol, or polyalkylene glycol such as polyethylene glycol with a halogen-containing epoxy compound such as epichlorohydrin. Another example includes a reaction product of polyhydric phenols such as resorcin, bis(4-hydroxyphenyl)dimethylmethan, a phenol formaldehyde resin and a resorcin formaldehyde resin, with a halogen-containing epoxy compound.

Examples of the isocyanate compound include 4,4′-diphenylmethandiisocyanate, tolylene 2,4-diisocyanate, polymethylene polyphenyl diisocyanate, hexamethylene diisocyanate and polyaryl polyisocyanate. Another example includes a blocked polyisocyanate, in which an isocyanate group of polyisocyanate is blocked by reacting the isocyanate with a blocking agent, such as phenols, tertiary alcohols or secondary alcohols.

Furthermore, for example, the core wires 4 with an adhesive of a two layer structure carried thereon may be subjected to post-treatment with an adhesive treating solution of a composition that contains the same components as the components of the adhesive layer 3, which is attached thereafter, and thus carry an adhesive of a three layer structure.

The back side layer 2 is formed generally with a thickness of 0.1-1 mm. An example of the canvas used for the back side layer 2 includes cloth plainly or diagonally weaved, or satin-weaved. Examples of a material of the canvas include, without intention to limit, polyester, cotton, polyamide having an aliphatic structure in a molecule, aramid as a wholly aromatic polyamide resin, acetalized polyvinyl alcohol, polyester, etc.

The material of the back side layer 2 is not necessarily limited to the canvas. The back side layer 2 may be formed by, for example, preparing an unvulcanized rubber sheet using a conventional rubber composition used for a V-ribbed belt, bringing this rubber sheet into contact with the adhesive layer 3, and then vulcanizing the sheet.

As another embodiment of the V-ribbed belt other than this embodiment, it is possible to provide a V-ribbed belt, in which the rubber composition that is incorporated with a rubber component containing an ethylene/α-olefin copolymer, and an organically treated clay mineral organically treated with an organic ammonium ion is used for not only the compression layer 5, but also the adhesive layer 3 or the back side layer 2. Alternatively, an embodiment, in which the rubber composition is used only for the adhesive layer 3 or the back side layer 2, is possible to be made.

Still as another embodiment, for example, a V-ribbed belt, in which the core wires are aligned in layers integrated together by the single rubber composition without differentiating the compression layer 5, the adhesive layer 3 and the back side layer 2 from each other, is possible to be made.

As yet another embodiment, for example, a V-ribbed belt, in which not the core wires 2 but canvas is embedded in the adhesive layer 3, is possible to be made.

A V-ribbed belt of this embodiment may be manufactured by, for example, the following method. First, the respective components of the rubber composition of the compression layer 5 are kneaded by a conventional rubber kneading means, such as a kneader, a Banbury mixer, a roll or a biaxial extruder to provide an unvulcanized rubber composition. Then, this unvulcanized rubber composition is formed into a sheet by a sheeting means, such as a calendar roll. Then, the sheet shaped unvulcanized rubber composition is laminated along with the canvas, a similarly sheet shaped rubber sheet of the adhesive layer, a tensile member and the like. Subsequently, this laminate is crosslinked and integrated together by a vulcanizing pan or the like to prepare a tubular preform. Then, predetermined ribs are formed on the tubular preform by using a grinding wheel or the like, and then the tubular preform is cut into pieces each having a predetermined number of ribs.

Although no detailed description will be made herein, a conventionally known technical matter in a rubber belt, such as a V-ribbed belt, a V belt and a flat belt may be employed in the rubber belt of the present invention to such an extent as not to significantly deteriorate the advantageous effects of the present invention.

### EXAMPLES

Now, a more detailed description will be made for the present invention by citing examples without intention to limit the present invention thereto.

### Example 1

### Producing a Rubber Composition

<Ethylene/α-Olefin Copolymer>

As an ethylene/α-olefin copolymer, an ethylene-propylene-diene copolymer (hereinafter referred also to EPDM) was used. As diene, EPDM using ethylidenenorbornene (hereinafter referred also to ENB) was used. The used ethylene/α-olefin copolymer will be described hereinbelow in detail.
EPDM (trade name: NORDEL IP 4725P, manufactured by Dow Chemical)

:100 parts by mass

Ethylene content: 70% by mass, ENB content: 5% by mass

Mooney viscosity: ML₁₊₄(125° C.)25

<Organically Treated Clay Mineral>
Organically treated montmorillonite: 10 parts by mass

Dimethyldioctadecylammonium-treated montmorillonite

(trade name: ESBEN NX, manufactured by HOJUN), organic matter content: 41.8% by mass

<Other Components in the Rubber Composition>
Carbon black (trade name: SEAST3, manufactured by Tokai Carbon Co., Ltd.): 30 parts by mass

HAF, arithmetic average particle diameter: 28 nm
Oil (trade name: SUNPAR 2280, manufactured by Sun Oil Co. Ltd.): 5 parts by mass
Zinc oxide (trade name: AENKA No. 3″, manufactured by Sakai Chemical Industry Co., Ltd.): 5 parts by mass
Stearic acid (trade name: BEADS STEARIC ACID TSUBAKI (transliterated), manufactured by NOF Corp.): 1 part by mass
Vulcanization accelerator (zinc dimethyl dithiocarbamate): 1 part by mass (trade name: NOCKSELLAR (transliterated) PZ, manufactured by Ouchi Shinko Chemical Industrial Co., Ltd.)
Sulfur (trade name: OIL SULFUR, manufactured by Tsurumi Chemical Industrial Co., Ltd.): 2 parts by mass

The above EPDM and the organically treated clay mineral are kneaded by a biaxial extruder, then extruded into a sheet by a roll, and again kneaded by the biaxial extruder. The produced admixture and other components were kneaded by using a Banbury mixer. Thus, a rubber composition of Example 1 was manufactured.

(Production of a V-Ribbed Belt)

<Preparation of an Unvulcanized Sheet of a Rubber Composition for a Compression Layer>

The rubber composition produced as mentioned above was formed into a sheet by a calendar roll to prepare an unvulcanized sheet of a rubber composition for a compression layer having a thickness of 0.8 mm.

<Preparation of an Unvulcanized Sheet of a Rubber Composition for an Adhesive Layer>

The components were kneaded in the following composition by using a Banbury mixer to prepare a rubber composition for an adhesive layer, and then the prepared rubber composition was molded into a sheet by a calendar roll to prepare an unvulcanized sheet of a rubber composition for an adhesive layer having a thickness of 0.4 mm.
EPDM (trade name: 3085, manufactured by Mitsui Chemicals, ethylene content: 62% by mass, propylene content: 33.5% by mass, diene content: 4.5% by mass): 100 parts by mass
Carbon black (trade name: IP600, manufactured by Showa Cabot K.K.): 50 parts by mass
Silica (trade name: TOKUSEAL GU, manufactured by Tokuyama Corp.): 20 parts by mass
Paraffin oil (trade name: SUNFLEX2280, manufactured by Japan Sun Kagaku K.K): 10 parts by mass
Vulcanizing agent (trade name: PERCUMYL D, manufactured by NOF Corporation) 2.5 parts by mass
Vulcanization accelerator (stearic acid manufactured by Kao Corp): 1 part by mass
Vulcanization accelerator (Zinc oxide manufactured by Sakai Chemical Industry Co., Ltd.): 5 parts by mass
Tackifier (trade name: QUINTON (transliterated) A-100, manufactured by Nippon Zeon Co., Ltd.): 5 parts by mass
Short fiber (cotton powder): 2 parts by mass

<Preparation of RFL Adhesive Composition>

7.31 parts by mass of resorcin and (37% by mass) 10.77 parts by mass of formalin were mixed together, then a sodium hydroxide aqueous solution (solid content: 0.33% by mass) was added thereto, then 160.91 parts by mass of water was added thereto, and then they were aged for 5 hours. Thus, a resorcin-formalin resin (resorcin-formalin initial condensate, hereinafter referred to RF, resorcin/formalin ratio=0.5) aqueous solution was prepared.

Then, a chlorosulfonated polyethylene latex (solid content: 40%) was mixed into an RF aqueous solution to have an RF/latex ratio=0.25 (solid content: 45.2 parts by mass), then water was further added thereto to have a solid content concentration of 20%, then the intermediate was stirred while being aged for 12 hours. Thus, an RFL adhesive composition was prepared.

<Preparation of a Tensile Member (Core Wire)>

Polyester cord manufactured by Teijin Limited (1000 deniers/2×3, final twisted threads: 9.5 T/10 cm (Z), primarily twisted threads: 2.19 T/10 cm) was immersed in a toluene solution of 4,4′-diphenylmethandiisocyanate (isocyanate solid content: 20% by mass), then dried by hot air at 240° C. for 40 seconds, and then subjected to pre-treatment. The core wire thus pre-treated was immersed in the RFL adhesive composition, then dried by hot air at 200° C. for 80 seconds, then immersed in a toluene solution of EPDM (trade name: 3085, manufactured by Mitsui Chemicals, ethylene content: 62% by mass, propylene content: 33.5% by mass, diene content: 4.5% by mass), and then dried by hot air at 60° C. for 40 seconds.

<Canvas>

Used as canvas was polyester cotton canvas [(characteristics when wide angle canvas is made), material of thread: canvas of mixture of polyester and cotton; mass ratio between polyester and cotton: 50:50; thread construction: weft: 20S/2 (representing two No. 20 threads twisted), weft: 20 S/2 (representing two No. 20 threads twisted), number of twisting times: weft S-twisting: 59 times/10 cm; weaving manner: canvas was plainly weaved with a crossing angle of weft and warp being 120°; thread density: 85 threads of weft/5 cm, 85 threads of warp/5 cm].

The above canvas and an unvulcanized sheet of the above rubber composition for rubber layer were wound around the outer circumference of a cylindrical molding drum having a smooth surface, and then the above tensile member (core wire) was spirally spun therearound. Then, the above unvulcanized sheet of the rubber composition for adhesive layer was laminated thereon, and finally, four unvulcanized sheets of the rubber composition for compression layer were laminated thereon. Then, this laminated body was placed in a vulcanizing pan and vulcanized with steam under an internal pressure of 0.59 MPa, an external pressure of 0.88 MPa at a temperature of 165° C. for 35 minutes. Thus, a cylindrical body was prepared.

This cylindrical body was mounted in a first driving system comprised of a driving roll and a driven roll, and then moved while ribs are formed with a grinding wheel to have three ribs for every 10 mm width. Then, this cylindrical body was mounted in a second driving system comprised of a driving roll and a driven roll, and cut into pieces while moving. Thus, a V-ribbed belt of Example 1 (width: 10 mm, circumferential length: 1000 mm) was produced.

### Example 2

A rubber composition and a V-ribbed belt, of Example 2 were produced in the same manner as Example 1, except that the content of organically treated montmorillonite of the rubber composition for compression layer is 20 parts by mass.

### Example 3

A rubber composition and a V-ribbed belt, of Example 3 were produced in the same manner as Example 1, except that the content of organically treated montmorillonite of the rubber composition for compression layer is 30 parts by mass.

### Example 4

A rubber composition and a V-ribbed belt, of Example 4 were produced in the same manner as Example 1, except that the content of organically treated montmorillonite of the rubber composition for compression layer is 6 parts by mass.

### Example 5

A rubber composition and a V-ribbed belt, of Example 5 were produced in the same manner as Example 1, except that, as EPDM of the rubber composition for compression layer, a material traded under the name “EP51”, manufactured by JSR Corp. (ethylene content: 67% by mass, ENB content: 5.8% by mass, Mooney viscosity: ML₁₊₄(125° C.)23) is used, and then this EPDM and the organically treated montmorillonite are kneaded by a Banbury mixer, then formed into a sheet by a roll and then kneaded by a biaxial extruder.

### Example 6

A rubber composition and a V-ribbed belt, of Example 6 were produced in the same manner as Example 5, except that, as EPDM of the rubber composition for compression layer, a material traded under the name “BUNA EP G 2470LM”, manufactured by Lanxess K.K. (ethylene content: 69% by mass, ENB content: 4.2% by mass, Mooney viscosity: ML₁₊₄(4(125° C.)22) is used.

### Example 7

A rubber composition and a V-ribbed belt, of Example 7 were produced in the same manner as Example 4, except that, as EPDM of the rubber composition for compression layer, a material traded under the name “Kelton 1446A”, manufactured by DSM Corp. (ethylene content: 60% by mass, ENB content: 6.6% by mass, Mooney viscosity: ML₁₊₄(125° C.)10) is used.

### Example 8

A rubber composition and a V-ribbed belt, of Example 8 were produced in the same manner as Example 4, except that, as EPDM of the rubber composition for compression layer, a material traded under the name “Kelton 5508”, manufactured by DSM Corp. (ethylene content: 70% by mass, ENB content: 4.5% by mass, Mooney viscosity: ML₁₊₄(125° C.)55) is used.

### Example 9

A rubber composition and a V-ribbed belt, of Example 9 were produced in the same manner as Example 1, except that, as EPDM of the rubber composition for compression layer, a material traded under the name “NDR 4820P”, manufactured by Dow Chemical Company (ethylene content: 85% by mass, ENB content: 4.9% by mass, Mooney viscosity: ML₁₊₄(125° C.)21) is used.

### Example 10

A rubber composition and a V-ribbed belt, of Example 10 were produced in the same manner as Example 4, except that, as EPDM of the rubber composition for compression layer, a material traded under the name “BUNA EP G 6250”, manufactured by Lanxess K.K. (ethylene content: 62% by mass, ENB content: 2.3% by mass, Mooney viscosity: ML₁₊₄(125° C.)55) is used.

### Example 11

A rubber composition and a V-ribbed belt, of Example 11 were produced in the same manner as Example 1, except that, as organically treated montmorillonite of the rubber composition for compression layer, a material traded under the name “ESBEN E”, manufactured by HOJUN, (trimethyloctadecylammonium-treated montmorillonite, organic matter content: 25.6% by mass) 10 parts by mass is used.

### Example 12

A rubber composition and a V-ribbed belt, of Example 12 were produced in the same manner as Example 1, except that the content of carbon black of the rubber composition for compression layer is 70 parts by mass in place of 30 parts by mass.

### Example 13

A rubber composition and a V-ribbed belt, of Example 13 were produced in the same manner as Example 1, except that the content of carbon black of the rubber composition for compression layer is 100 parts by mass in place of 30 parts by mass.

### Example 14

A rubber composition of Example 14 was produced in the same manner as Example 1, except that the content of carbon black of the rubber composition for compression layer is 10 parts by mass in place of 30 parts by mass.

### Example 15

A rubber composition of Example 15 was produced in the same manner as Example 1, except that the content of carbon black of the rubber composition for compression layer is 110 parts by mass in place of 30 parts by mass.

### Example 16

A rubber composition of Example 16 was produced in the same manner as Example 1, except that no carbon black was incorporated into the rubber composition for compression layer.

### Comparative Example 1

A rubber composition and a V-ribbed belt, of Comparative Example 1 were produced in the same manner as Example 1, except that organically treated montmorillonite of the rubber composition for compression layer is incorporated in 5 parts by mass.

### Comparative Example 2

A rubber composition and a V-ribbed belt, of Comparative Example 2 were produced in the same manner as Example 1, except that organically treated montmorillonite of the rubber composition for compression layer is incorporated in 50 parts by mass.

### Comparative Example 3

A rubber composition and a V-ribbed belt, of Comparative Example 3 were produced in the same manner as Example 1, except that no organically treated montmorillonite is incorporated into the rubber composition for compression layer and carbon black is incorporated in 70 parts by mass.

### Comparative Example 4

A rubber composition and a V-ribbed belt, of Comparative Example 4 were produced in the same manner as Example 4, except that, as EPDM of the rubber composition for compression layer, a material traded under the name “Nordel IP 4640”, manufactured by Dow Chemical Company (ethylene content: 55% by mass, ENB content: 5% by mass, Mooney viscosity: ML₁₊₄(125° C.)40) is incorporated in 100 parts by mass.

### Comparative Example 5

A rubber composition and a V-ribbed belt, of Comparative Example 5 were produced in the same manner as Example 1, except that, as EPDM of the rubber composition for compression layer, a material traded under the name “EP57c”, manufactured by JSR Corp. (ethylene content: 66% by mass, ENB content: 4.5% by mass, Mooney viscosity: ML₁₊₄(125° C.)58) is incorporated in 100 parts by mass.

### Comparative Example 6

A rubber composition and a V-ribbed belt, of Comparative Example 6 were produced in the same manner as Example 1, except that, as EPDM of the rubber composition for compression layer, a material traded under the name “Nordel IP 4520”, manufactured by Dow Chemical Company (ethylene content: 50% by mass, ENB content: 4.9% by mass, Mooney viscosity: ML₁₊₄(125° C.)20) is incorporated in 100 parts by mass.

### Comparative Example 7

A rubber composition and a V-ribbed belt, of Comparative Example 7 were produced in the same manner as Example 1, except that, as EPDM of the rubber composition for compression layer, a material traded under the name “BUNA EP T 6861”, manufactured by Lanxess K.K. (ethylene content: 60% by mass, ENB content: 8.0% by mass, Mooney viscosity: ML₁₊₄(125° C.)60) is incorporated in 100 parts by mass.

### Comparative Example 8

A rubber composition and a V-ribbed belt, of Comparative Example 8 were produced in the same manner as Example 1, except that, as EPDM of the rubber composition for compression layer, a material traded under the name “BUNA EP G 4670”, manufactured by Lanxess K.K. (ethylene content: 70% by mass, ENB content: 4.7% by mass, Mooney viscosity: ML₁₊₄(125° C.)59) is incorporated in 100 parts by mass.

### Comparative Example 9

A rubber composition and a V-ribbed belt, of Comparative Example 9 were produced in the same manner as Example 1, except that the content of organically treated montmorillonite of the rubber composition for compression layer is 35 parts by mass in place of 10 parts by mass.

(Breaking Strength and Breaking Elongation by a Tensile Test)

Vulcanized and molded sheets using the rubber compositions produced in the respective Examples and Comparative Examples were prepared.

Evaluation specimens of dumbbell No. 3 prescribed in JIS K6521 were prepared using the sheets, and were evaluated in terms of the breaking strength (MPa) and the breaking elongation (%) by tensile tests. Also, a tensile product, which is the product of the breaking strength (MPa) and the breaking elongation (%), was calculated. A test machine used was “STROGRAPH AE” manufactured by Toyo Seiki Seisaku-sho, LTD. The vulcanization conditions for the evaluation specimens were the same as those applied in producing the V-ribbed belt of Example 1.

The tensile tests were carried out according to JIS K6251, and the evaluations were made, in which the value of tensile stress (TS_{b}) at the time of breaking was designated as breaking strength, and the value of elongation (E_{b}) at the time of breaking was designated as breaking elongation.

The evaluation results are shown in Table 1.

(Number of Times of Flexing or Bending by a De Mattia Flex Test)

Evaluation specimens were prepared using the rubber compositions of the respective Examples and Comparative Examples, and were evaluated in terms of the number of times of flexing or bending until breaking by a De Mattia flex test under the conditions with a stroke length of 60-80 mm and at a temperature of 23° C. according to JIS 6260. A tester used was “FT-1500 series” manufactured by Ueshima Seisakusho Co. Ltd. The vulcanization conditions for the evaluation specimens were the same as those applied in producing the V-ribbed belt of Example 1. The evaluation results are shown in Table 1.

(Evaluation of Flex Endurance Time by a Belt Running Test)

FIG. 2 is a schematic view of a belt running tester in a flex endurance evaluation of a V-ribbed belt. This belt running tester includes large diameter rib pulleys having a diameter of 120 mm and disposed at upper and lower sides (an upper one is a driven pulley 51 and a lower one is a driving pulley 52), an idler pulley 54 having a diameter of 70 mm and disposed on a right-hand side at a vertical center, and a small diameter rib pulley 53 having a diameter of 55 mm and disposed on the right hand side of the idler pulley 54. The idler pulley 54 is disposed with a belt winding angle of 90°.

The V-ribbed belts produced in the respective Examples and Comparative Examples each are wound around the three rib pulleys 51-53, and then wound around the idler pulley 54 to allow the back side of each belt to come into contact the idler pulley 54. Then, the rib pulley 53 is pulled laterally to have a set weight of 834 N, and a belt running test is carried out by rotating the lower rib pulley 52 at 4900 rpm under the conditions at 120° C. The belt is stopped running at every predetermined interval and the rib surface of the belt is visually observed and the running time until a crack is observed is designated as the flex endurance time. The results of the evaluations are shown in Tables 1 and 2.

TABLE 1
UNIT OF CONTENT: PART BY MASS

| | | Example 1 | Example 2 | Example 3 | Example 4 | Example 5 | Example 6 | Example 7 | Example 8 |
|---|---|---|---|---|---|---|---|---|---|
| CONTENT | EPDM (ND4725)*¹ | 100 | 100 | 100 | 100 | | | | |
| | EPDM (EP51)*² | | | | | 100 | | | |
| | EPDM (BUNA EPG 2470)*³ | | | | | | 100 | | |
| | EPDM (Kelton 1446A)*⁴ | | | | | | | 100 | |
| | EPDM (Kelton 5508)*⁵ | | | | | | | | 100 |
| | EPDM (NDR4820)*⁶ | | | | | | | | |
| | EPDM (BUNA EPG 6250)*⁷ | | | | | | | | |
| | ORGANICALLY TREATED | 10 | 20 | 30 | 6 | 10 | 10 | 10 | 10 |
| | MONTMORILLONITE*⁸ | | | | | | | | |
| | ORGANICALLY TREATED | | | | | | | | |
| | MONTMORILLONITE*⁹ | | | | | | | | |
| | CARBON BLACK | 30 | 30 | 30 | 30 | 30 | 30 | 30 | 30 |
| | OIL | 5 | 5 | 5 | 5 | 5 | 5 | 5 | 5 |
| | ZINK OXIDE | 5 | 5 | 5 | 5 | 5 | 5 | 5 | 5 |
| | STEARIC ACID | 1 | 1 | 1 | 1 | 1 | 1 | 1 | 1 |
| | VULCANIZATION | 1 | 1 | 1 | 1 | 1 | 1 | 1 | 1 |
| | ACCELERATOR | | | | | | | | |
| | SULFUR | 2 | 2 | 2 | 2 | 2 | 2 | 2 | 2 |
| EVALUATION | BREAKING STRENGTH (MPa) | 30.5 | 27.6 | 26.8 | 25.1 | 28.7 | 29.7 | 26.1 | 25.8 |
| | BREAKING ELONGATION (%) | 594 | 613 | 625 | 563 | 581 | 568 | 574 | 565 |
| | TENSILE PRODUCT | 18117 | 16918 | 16750 | 14131 | 16675 | 16870 | 14981 | 14577 |
| | NUMBER OF TIMES OF | 100000 | 100000 | 100000 | 90000 | 100000 | 100000 | 90000 | 90000 |
| | FLEXING OR BENDING | OR | OR | OR | OR | OR | OR | OR | OR |
| | UNTILBREAKAGE (DE | MORE | MORE | MORE | MORE | MORE | MORE | MORE | MORE |
| | MATTIA METHOD) | | | | | | | | |
| | BELT FLEX ENDURANCE | 1350 | 1400 | 1200 | 1000 | 1300 | 1200 | 1100 | 1000 |
| | TIME (HOUR) | | | | | | | | |
| | | | Example | Example | Example | Example | Example | Example | Example |
| | | Example 9 | 10 | 11 | 12 | 13 | 14 | 15 | 16 |
| CONTENT | EPDM (ND4725)*¹ | 100 | | 100 | 100 | 100 | 100 | 100 | 100 |
| | EPDM (EP51)*² | | | | | | | | |
| | EPDM (BUNA EPG 2470)*³ | | | | | | | | |
| | EPDM (Kelton 1446A)*⁴ | | | | | | | | |
| | EPDM (Kelton 5508)*⁵ | | | | | | | | |
| | EPDM (NDR4820)*⁶ | 100 | | | | | | | |
| | EPDM (BUNA EPG 6250)*⁷ | | 100 | | | | | | |
| | ORGANICALLY TREATED | 10 | 10 | | 10 | 10 | 10 | 10 | 10 |
| | MONTMORILLONITE*⁸ | | | | | | | | |
| | ORGANICALLY TREATED | | | 10 | | | | | |
| | MONTMORILLONITE*⁹ | | | | | | | | |
| | CARBON BLACK | 30 | 30 | 30 | 70 | 100 | 10 | 110 | |
| | OIL | 5 | 5 | 5 | 5 | 5 | 5 | 5 | 5 |
| | ZINK OXIDE | 5 | 5 | 5 | 5 | 5 | 5 | 5 | 5 |
| | STEARIC ACID | 1 | 1 | 1 | 1 | 1 | 1 | 1 | 1 |
| | VULCANIZATION | 1 | 1 | 1 | 1 | 1 | 1 | 1 | 1 |
| | ACCELERATOR | | | | | | | | |
| | SULFUR | 2 | 2 | 2 | 2 | 2 | 2 | 2 | 2 |
| EVALUATION | BREAKING STRENGTH (MPa) | 25.9 | 25.2 | 27.8 | 20.5 | 20.2 | 30.6 | 20 | 26.3 |
| | BREAKING ELONGATION (%) | 576 | 553 | 576 | 328 | 296 | 647 | 220 | 554 |
| | TENSILE PRODUCT | 14918 | 13936 | 16013 | 6724 | 5979 | 19798 | 4400 | 14570 |
| | NUMBER OF TIMES OF | 100000 | 90000 | 90000 | 100000 | 90000 | 90000 | 80000 | 100000 |
| | FLEXING OR BENDING | OR | OR | OR | OR | OR | OR | OR | OR |
| | UNTILBREAKAGE (DE | MORE | MORE | MORE | MORE | MORE | MORE | MORE | MORE |
| | MATTIA METHOD) | | | | | | | | |
| | BELT FLEX ENDURANCE | 1150 | 1100 | 1000 | 1400 | 1000 | — | — | — |
| | TIME (HOUR) | | | | | | | | |

*¹EPDM (ND4725): Ethylene content of 70% by mass, ENB content of 5.0% by mass, Mooney viscosity of ML₁₊₄(125° C.) 25
*²EPDM (EP51): Ethylene content of 67% by mass, ENB content of 5.8% by mass, Mooney viscosity of ML₁₊₄(125° C.) 23
*³EPDM (BUNA EPG 2470): Ethylene content of 69% by mass, ENB content of 4.2% by mass, Mooney viscosity of ML₁₊₄(125° C.) 22
*⁴EPDM (Kelton 1446A): Ethylene content of 60% by mass, ENB content of 6.6% by mass, Mooney viscosity of ML₁₊₄(125° C.) 10
*⁵EPDM (Kelton 5508): Ethylene content of 70% by mass, ENB content of 4.5% by mass, Mooney viscosity of ML₁₊₄(125° C.) 55
*⁶EPDM (NDR4820): Ethylene content of 85% by mass, ENB content of 4.9% by mass, Mooney viscosity of ML₁₊₄(125° C.) 21
*⁷EPDM (BUNA EPG 6250): Ethylene content of 62% by mass, ENB content of 2.3% by mass, Mooney viscosity of ML₁₊₄(125° C.) 55
*⁸Organically treated montmorillonite 1: dimethyloctadecylammonium-treated montmorillonite, organic matter content of 41.8% by mass
*⁹Organically treated montmorillonite 2: trimethyloctadecylammonium-treated montmorillonite, organic matter content of 25.6% by mass

TABLE 2
UNIT OF CONTENT: PART BY MASS

| | | Comparative | Comparative | Comparative | Comparative | Comparative |
|---|---|---|---|---|---|---|
| | | Example 1 | Example 2 | Example 3 | Example 4 | Example 5 |
| CONTENT | EPDM (ND4725)*¹ | 100 | 100 | 100 | | |
| | EPDM (ND4640)*¹⁰ | | | | 100 | |
| | EPDM (EP57c)*¹¹ | | | | | 100 |
| | EPDM (ND4520)*¹² | | | | | |
| | EPDM (BUNA EP T | | | | | |
| | 6861)*¹³ | | | | | |
| | EPDM (BUNA EP G | | | | | |
| | 4670)*¹⁴ | | | | | |
| | ORGANICALLY | 5 | 50 | | 10 | 10 |
| | TREATED | | | | | |
| | MONTMORILLONITE*⁸ | | | | | |
| | CARBON BLACK | 30 | 30 | 70 | 30 | 30 |
| | OIL | 5 | 5 | 5 | 5 | 5 |
| | ZINC OXIDE | 5 | 5 | 5 | 5 | 5 |
| | STEARIC ACID | 1 | 1 | 1 | 1 | 1 |
| | VULCANIZATION | 1 | 1 | 1 | 1 | 1 |
| | ACCELERATOR | | | | | |
| | SULFUR | 2 | 2 | 2 | 2 | 2 |
| EVALUATION | BREAKING STRENGTH | 18.2 | 15.3 | 23.6 | 16.3 | 18.4 |
| | (MPa) | | | | | |
| | BREAKING ELONGATION | 303 | 547 | 232 | 470 | 422 |
| | (%) | | | | | |
| | TENSILE PRODUCT | 5515 | 8369 | 5475 | 7611 | 7765 |
| | NUMBER OF TIMES OF | 80000 | 60000 | 15000 | 70000 | 70000 |
| | FLEXING OR BENDING | | | | | |
| | UNTIL BREAKAGE (DE | | | | | |
| | MATTIA METHOD) | | | | | |
| | BELT FLEX ENDURANCE | 1000 | 700 | 500 | 950 | 950 |
| | TIME (HOUR) | | | | | |

| | | Comparative | Comparative | Comparative | Comparative |
|---|---|---|---|---|---|
| | | Example 6 | Example 7 | Example 8 | Example 9 |
| CONTENT | EPDM (ND4725)*¹ | | | | |
| | EPDM (ND4640)*¹⁰ | | | | |
| | EPDM (EP57c)*¹¹ | | | | |
| | EPDM (ND4520)*¹² | 100 | | | |
| | EPDM (BUNA EP T | | 100 | | |
| | 6861)*¹³ | | | | |
| | EPDM (BUNA EP G | | | 100 | |
| | 4670)*¹⁴ | | | | |
| | ORGANICALLY | 10 | 10 | 10 | 35 |
| | TREATED | | | | |
| | MONTMORILLONITE*⁸ | | | | |
| | CARBON BLACK | 30 | 30 | 30 | 30 |
| | OIL | 5 | 5 | 5 | 5 |
| | ZINC OXIDE | 5 | 5 | 5 | 5 |
| | STEARIC ACID | 1 | 1 | 1 | 1 |
| | VULCANIZATION | 1 | 1 | 1 | 1 |
| | ACCELERATOR | | | | |
| | SULFUR | 2 | 2 | 2 | 2 |
| EVALUATION | BREAKING STRENGTH | 16.4 | 18.2 | 19.6 | 21.9 |
| | (MPa) | | | | |
| | BREAKING ELONGATION | 420 | 486 | 476 | 530 |
| | (%) | | | | |
| | TENSILE PRODUCT | 6888 | 8845 | 9330 | 11607 |
| | NUMBER OF TIMES OF | 60000 | 80000 | 80000 | 90000 |
| | FLEXING OR BENDING | | | | |
| | UNTIL BREAKAGE (DE | | | | |
| | MATTIA METHOD) | | | | |
| | BELT FLEX ENDURANCE | 800 | 1000 | 900 | 900 |
| | TIME (HOUR) | | | | |

*¹EPDM (ND4725): Ethylene content of 70% by mass, ENB content of 5.0% by mass, Mooney viscosity of ML₁₊₄(125° C.) 25
*⁸Organically treated montmorillonite 1: dimethyloctadecylammonium-treated montmorillonite, organic matter content of 41.8% by mass
*¹⁰EPDM (ND4640): Ethylene content of 55% by mass, ENB content of 5.0% by mass, Mooney viscosity of ML₁₊₄(125° C.) 40
*¹¹EPDM (EP57c): Ethylene content of 66% by mass, ENB content of 4.5% by mass, Mooney viscosity of ML₁₊₄(125° C.) 58
*¹²EPDM (ND4720): Ethylene content of 50% by mass, ENB content of 4.9% by mass, Mooney viscosity of ML₁₊₄(125° C.) 20
*¹³EPDM (BUNA EP T 6861): Ethylene content of 60% by mass, ENB content of 8.0% by mass, Mooney viscosity of ML₁₊₄(125° C.) 60
*¹⁴EPDM (BUNA EP G 4670): Ethylene content of 70% by mass, ENB content of 4.7% by mass, Mooney viscosity of ML₁₊₄(125° C.) 59

From Tables 1 and 2, the followings are recognizable. Specifically, a mold formed by the rubber composition of each of Examples is improved in terms of the mechanical properties, such as breaking strength, breaking elongation and number of times of flexing or bending until breakage, as compared with a rubber composition of each of Comparative Examples. Also, the V-ribbed belt of each of Examples is improved in terms of the mechanical properties, such as the belt flex endurance time, as compared with the V-ribbed belt of each of Comparative Examples.

1. A rubber composition comprising a rubber component containing an ethylene/α-olefin copolymer, and an organically treated clay mineral organically treated with an organic ammonium ion, wherein the ethylene content of the ethylene/α-olefin copolymer is in a range of 60-85% by mass, the rubber component has a Mooney viscosity of 10-55 at 125° C., and the organically treated clay mineral is incorporated in 6-30 parts by mass per 100 parts by mass of the rubber component.

2. The rubber composition according to claim 1, further comprising carbon black, wherein the carbon black is incorporated in 30-100 parts by mass per 100 parts by mass of the rubber component.

3. The rubber composition according to claim 1, wherein a mold formed by vulcanization molding has a breaking strength of 25-35 MPa and a breaking elongation of 550-700%.

4. A rubber belt formed by using a rubber composition that comprises a rubber component containing an ethylene/α-olefin copolymer, and an organically treated clay mineral organically treated with an organic ammonium ion, wherein the ethylene content of the ethylene/α-olefin copolymer is in a range of 60-85% by mass, the rubber component has a Mooney viscosity of 10-55 at 125° C., and the organically treated clay mineral is incorporated in 6-30 parts by mass per 100 parts by mass of the rubber component.

5. The rubber belt according to claim 4, wherein the rubber composition further comprises carbon black, which is incorporated in 30-100 parts by mass per 100 parts by mass of the rubber component.

6. The rubber belt according to claim 4, wherein the rubber composition is used in vulcanized state, and a portion of the rubber belt, which is formed by the rubber composition has a breaking strength of 25-35 MPa and a breaking elongation of 550-700%.

7. The rubber belt according to claim 4, which is a conveyor belt comprising a compression layer formed by the rubber composition.

8. The rubber composition according to claim 2, wherein a mold formed by vulcanization molding has a breaking strength of 25-35 MPa and a breaking elongation of 550-700%.

9. The rubber belt according to claim 5, wherein the rubber composition is used in vulcanized state, and a portion of the rubber belt, which is formed by the rubber composition has a breaking strength of 25-35 MPa and a breaking elongation of 550-700%.

10. The rubber belt according to claim 5, which is a conveyor belt comprising a compression layer formed by the rubber composition.

11. The rubber belt according to claim 6, which is a conveyor belt comprising a compression layer formed by the rubber composition.

12. The rubber belt according to claim 9, which is a conveyor belt comprising a compression layer formed by the rubber composition.
